(19) United States
(12) Patent Application Publication
(10) Pub. No.: US 2011/0259051 A1
(43) Pub. Date: Oct. 27, 2011

(54) PERSONALIZED COMMEMORATIVE PENDANT

(76) Inventor: Woodrow C. Stillwagon, Greenville, SC (US)

(21) Appl. No.: 12/788,871

(22) Filed: May 27, 2010

Related U.S. Application Data
(60) Provisional application No. 61/327,918, filed on Apr. 26, 2010.

(51) Int. Cl. A44C 25/00; G09F 3/00

(52) U.S. Cl. 63/33; 40/299.01

(57) ABSTRACT

A reduced-sized replica of an original certificate commemorating a significant event or achievement is disposed on a wearable or transportable personal item, such as an article of jewelry or personal accessory. The replica may be printed or engraved directly on the personal item or on a tag that is then affixed to the personal item or personal accessory.

### CROSS REFERENCE TO RELATED APPLICATIONS

This application claim priority to U.S. Provisional Patent Application No. 61/327,918 filed Apr. 26, 2010, which is incorporated herein by reference.

### FIELD OF THE INVENTION

The present invention relates to a wearable pendant or displayable tag and, more particularly, to personalized jewelry or tags containing an accurate replica of an important certificate or notice.

### BACKGROUND OF THE INVENTION

During the life of an individual, one or more significant events are announced to family, friends and the public by way of a formal invitation, notice, certificate or the like. Notification of a graduation, wedding invitations, baby birth announcements, accountant certification, board certification, bar certification, and notices of association with a firm are typically commemorated with a formal invitations, certificates, notices, announcements or the like, otherwise referred to as original certificates.

Recipients of such original certificates often enjoy a daily reminder of the underlying event or achievement. Although many inventions are documented that relate to methods of printing names, dates, and the like upon jewelry and tags, no apparatus is yet available wherein an accurate replica of an original certificate—generally along with its text, logos, seals, and signatures—is disposed upon the article of jewelry or transportable tag to provide the daily reminder sought.

What is needed is a wearable article of jewelry that contains a reduced-size, accurate replica of the original certificate. What is also needed is a transportable or wearable tag that contains a reduced-size, accurate replica of the original certificate.

### BRIEF DESCRIPTION OF THE INVENTION

The present invention seeks to provide an article of jewelry, such as a personalized pendant, or a transportable tag that displays a reduced replica of an original certificate commemorating an achievement or significant event in the life of the recipient, family member, or friend.

The present invention solves the above-stated needs by providing an article of jewelry displaying a reduced-sized replica of an important certificate, comprising a wearable article of jewelry, where the article of jewelry has an accurate replica of an original certificate disposed thereon. In one embodiment, the original certificate represents an event in the life of a recipient of the original certificate. In another embodiment, the original certificate represents an achievement in the life of a recipient of the original certificate. In another embodiment the original certificate represents an achievement in the life of a family member or friend.

The invention further solves the above need by providing a transportable or wearable tag displaying a reduced-sized replica of an original certificate. In one embodiment the original certificate represents an event in the life of the recipient of the original certificate. In another embodiment the original certificate represents an achievement in the life of a recipient of the original certificate. In yet another embodiment the original certificate represents an achievement in the life of a family member or friend.

### BRIEF DESCRIPTION OF THE DRAWINGS

FIG. 1 illustrates a pendant displaying a reduced-sized replica of an original certificate.

FIG. 2 illustrates a blank pendant with an islet.

FIG. 3 illustrates a blank tag.

FIG. 4 illustrates an original certificate, in the form of a formal invitation, and a reduced-sized replica of the original certificate.

FIG. 5 illustrates a reduced-sized replica of an original certificate being laser-engraved onto a pendant.

FIG. 6 illustrates a reduced-sized replica of an original certificate printed on a decal, where the decal is then affixed to a pendant.

FIG. 7 illustrates a reduced-sized replica of an original certificate being printed onto a pendant.

### DETAILED DESCRIPTION OF THE INVENTION

The present invention provides an apparatus for displaying an original certificate in a manner that provides a daily reminder of the significant event or achievement set forth in the original certificate. In the context of the present invention, an original certificate refers to a formal invitation, notice, certificate, or the like, generally issued to commemorate a significant event or achievement in the life of the recipient. Original certificates can be important to both the recipient and to family members and friends because they often contain important information of sentimental value. Original certificates are most often notifications of a graduation, wedding invitations, diplomas, baby birth announcements, accountant certification, board certification, bar certification, and notices of association with a firm, that are typically commemorated with a formal invitation, certificate, notice, announcement, or the like.

As such, an event in the life of a recipient may be any number of significant occurrences that is memorialized in an original certificate, such as a wedding, anniversary, or the like. An achievement in the life of a recipient can likewise be any number of significant achievements, such as receipt of a new credential, entry into an order, diploma, or the like. An original certificate may also reflect an achievement in the life of a family member or friend, such as a high school diploma, college degree, or the like.

One of the best ways to provide a daily reminder comes in the form of an article of jewelry, such as a wearable pendant or bracelet. An article of jewelry can be any wearable device normally referred to as jewelry, which is also capable of displaying a reduced-sized replica of an original certificate. The owner may wear this jewelry every day and view whatever may be disposed thereon. In a preferred embodiment of the invention, a reduced-sized replica of an original certificate is printed directly onto a pendent that is in turn worn daily. In this manner, the wearer may view the original certificate at any time to remind himself of the achievement or significant event underlying the original certificate.

The invention may be embodied as a rectangular pendant made of one of a number of common ornamental materials, such as platinum, gold, gold plate, silver, silver plate, nickel, nickel plate, brass, bronze, copper or other metals, wood, plastic, acrylic, glass, leather, ceramic, or the like. The pendent serves as the element upon which the reduced certificate is replicated. The replica can be laser engraved into the pendant. The disturbed surface of the pendant can also be highlighted with the addition of colorant. The replica can also be laser printed on decal material and affixed to the pendant. It is even possible that the replica may be printed directly onto the surface of the pendent by a standard ink jet or laser printer. In that case, a receptive coating is generally desirable on the pendent in advance of printing. The final, decorated pendent is preferably coated with one or more protective coatings to resist wear, chemicals, water and light.

Another way to provide a daily reminder is a tag that is attached to any number of transportable or wearable devices, such as pins, bracelets, mementos, money clips, key rings or keepsake vessels. The owner can easily view the tag on a daily basis. In another preferred embodiment of the invention, a reduced-sized replica of an original certificate is printed directly onto a tag that is in turn affixed to a transportable or wearable device where it may be easily viewed. In this manner, the owner may view the original certificate at any time to remind himself of the achievement or significant event underlying the original certificate.

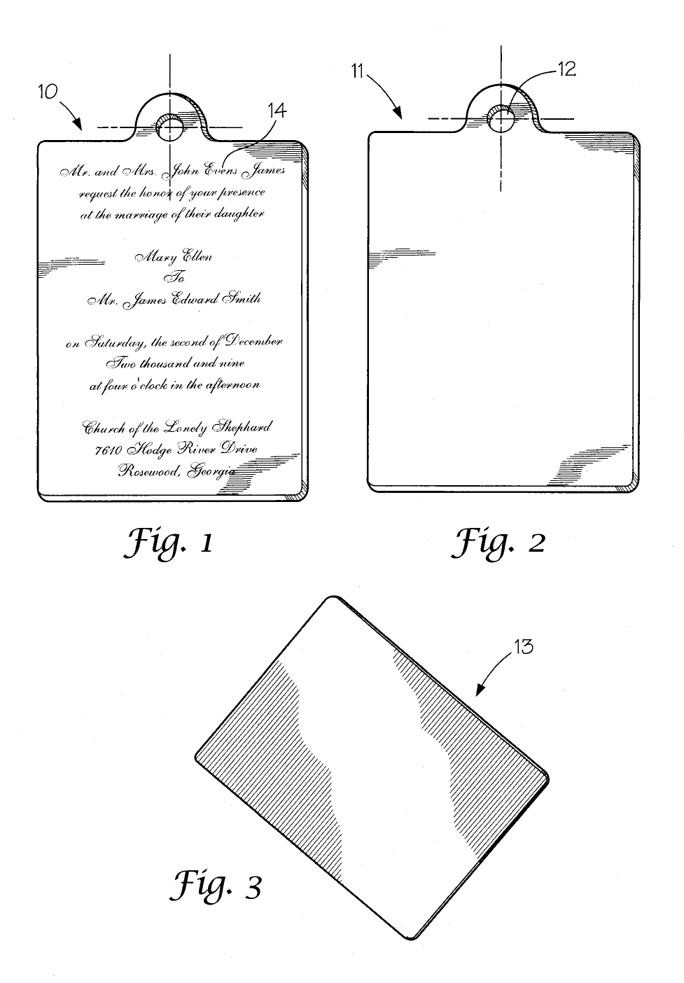

Referring now to FIG. 1, a pendent 10 is illustrated displaying a reduced-sized replica 14 of an original certificate. The replica 14 is preferably engraved or printed directly onto the surface of pendant 10.

FIG. 2 illustrates a blank pendant 11 with an islet 12, which islet 12 is typically used to attach pendant 11 to an article of jewelry, such as a necklace, bracelet, pin or the like.

FIG. 3 illustrates blank tag 13, which may be used to carry a printed or engraved original certificate in reduced size. Tag 13 can be affixed to any number of personal accessories. A personal accessory in the context of the instant invention is a transportable or wearable device, such as a pin, bracelet, memento, money clip, key ring, keepsake vessel, or the like. Pendant 11 and tag 13 can be made of any number of materials, such as base metals, plated metals, wood, plastic, glass, acrylic, leather, ceramics or other suitable stratum. The perimeter of the pendant 11 or tag 13 can be embossed, debossed, or decorated to enhance appearance.

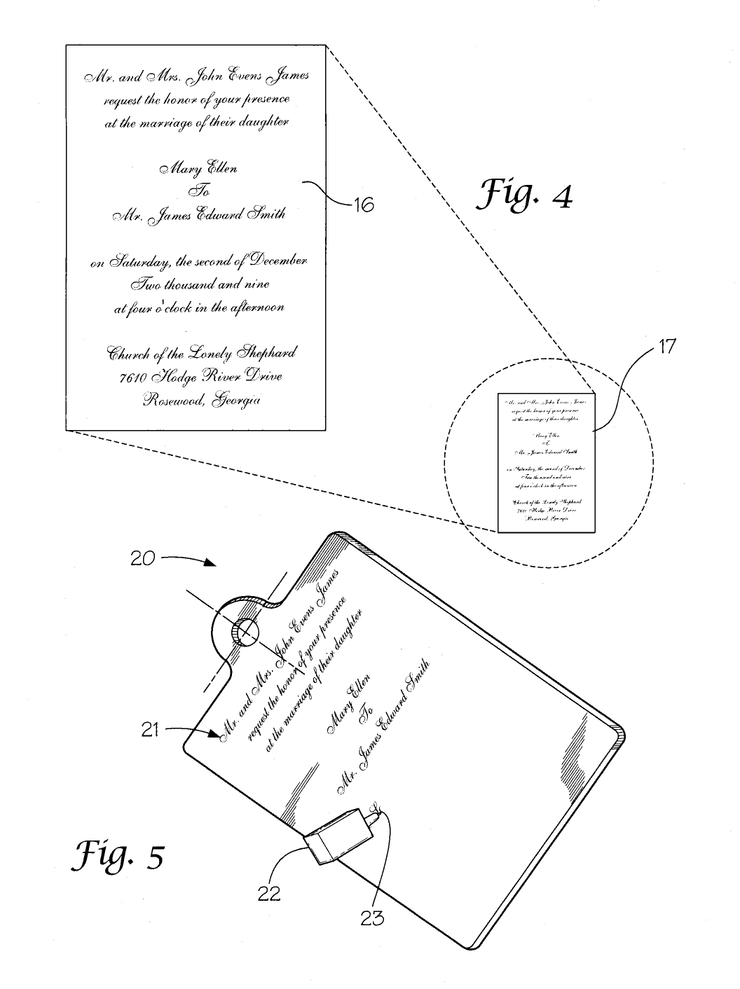

FIG. 4 illustrates a full-sized original certificate 16. In this case, the original certificate is a formal invitation, which is copied and reduced in size to replica 17. Original certificate 16 is typically scanned into an electronic format using available scanning technology. The image of certificate 16 is then electronically reduced using commonly known image reduction technology. The image of reduced-size replica 17 is then generally stored in electronic format for use and replication via laser engraver or laser printers.

In the embodiment illustrated in FIG. 5, an electronically stored reduced-sized replica, such as replica 17, is shown being laser engraved onto an article of jewelry. In this example, the article of jewelry is pendant 20. In other embodiments, the article of jewelry can be any wearable device normally referred to as jewelry, which is also capable of displaying a reduced-sized replica of an original certificate.

The engraved surface 21 is created by laser head 22, which can be controlled by any standard computer software and laser engraving system. Here laser head 22 imparts a focused laser beam that strikes the laser contact point 23 to generate the engraved text of the reduced-sized replica as engraved surface 21. Typical lasers, such as YAG or CO2 (typically with special optics), can engrave the widest range of materials. Once the engraving is complete, a secondarily applied colorant may then be applied to highlight some or all of surface 21.

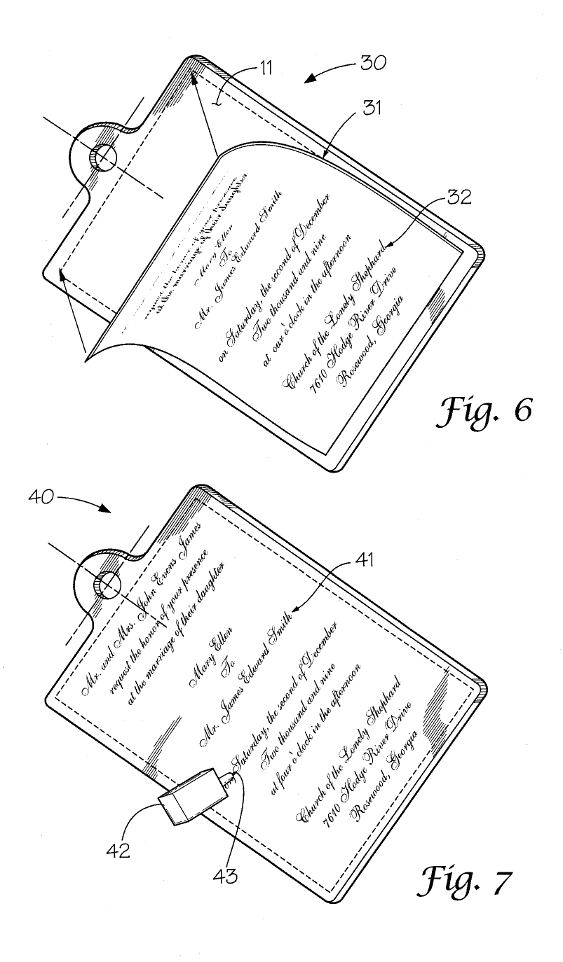

FIG. 6 illustrates a reduced-sized replica of an original certificate printed on a decal, where the decal is then affixed to a pendant 30. Decal 31 is generally pre-printed with text of the reduced-sized replica 32 and cut for contact application to blank pendant 11. Generally either a wet-slide or dry-slide process is used to apply decal 31 to wearable or transportable surfaces such as blank pendant 11 or blank tag 13.

FIG. 7 illustrates a reduced-sized replica of an original certificate being laser printed onto a pendant 40. In this embodiment, pendant 40 is preferably coated with an emulsion that retains laser-applied inks. The ink is then applied via laser printer head 42 and text of the reduced-sized replica 41 is made visible at the printer contact point 43 Ink-printed pendent 40 offers the benefit of perhaps the greatest flexibility in the application of colorant to the text because color laser printers are capable of printing a nearly infinite range of colors.

These illustrated examples are offered by way of illustration of the invention's versatility and not meant to limit the invention in any way. The present invention may be embodied in other specific forms without departing from its spirit of essential characteristics. The described embodiments are to be considered in all respects only illustrative and not restrictive. The scope of the invention is therefore indicated by the appended claims rather than by the foregoing description. All changes which come within the meaning and scope of equivalency of the claims are to be embraced within their scope.

I claim:

1. An article of jewelry displaying a reduced-sized replica of an important certificate, comprising:
a wearable article of jewelry, said article of jewelry having an accurate replica of an original certificate disposed thereon.

2. The article of jewelry of claim 1 wherein said original certificate represents an event in the life of a recipient of said original certificate.

3. The article of jewelry of claim 1 wherein said original certificate represents an achievement in the life of a recipient of said original certificate.

4. The article of jewelry of claim 1 wherein said original certificate represents an achievement in the life of one of a family member and friend.

5. A transportable tag displaying a reduced-sized replica of an original certificate comprising:
a tag, wherein said tag has an accurate replica of an original certificate disposed thereon, and wherein said tag is affixed to a personal accessory.

6. The tag of claim 5 wherein said original certificate represents an event in the life of a recipient of said original certificate.

7. The tag of claim 5 wherein said original certificate represents an achievement in the life of a recipient of said original certificate.

8. The tag of claim 5 wherein said original certificate represents an achievement in the life of one of a family member and friend.

9. An article of jewelry displaying a reduced-sized replica of an original certificate comprising:
a tag, wherein said tag has an accurate replica of an original certificate disposed thereon, and wherein said tag is affixed to an article of jewelry.

10. The article of jewelry of claim 9 wherein said original certificate represents an event in the life of a recipient of said original certificate.

11. The article of jewelry of claim 9 wherein said original certificate represents an achievement in the life of a recipient of said original certificate.

12. The article of jewelry of claim 9 wherein said original certificate represents an achievement in the life of one of a family member and friend.
